(19) United States
(12) Patent Application Publication
(10) Pub. No.: US 2015/0286341 A1
(43) Pub. Date: Oct. 8, 2015

(54) multi-touch ultrasonic touch screen

(71) Applicant: THE BOARD OF TRUSTEES OF THE LELAND STANFORD JUNIOR UNIVERSITY, Palo Alto, CA (US)

(72) Inventors: Butrus T. Khuri-Yakub, Palo Alto, CA (US); Amin Nikoozadeh, Palo Alto, CA (US); Kamyar Firouzi, Stanford, CA (US)

(21) Appl. No.: 14/646,074

(22) PCT Filed: Nov. 19, 2013
(86) PCT No.: PCT/US2013/070792

§ 371 Date: May 20, 2015

Related U.S. Application Data
(60) Provisional application No. 61/729,197, filed on Nov. 21, 2012.

(51) Int. Cl. G06F 3/043

(52) U.S. Cl. CPC G06F 3/0436; G06F 2203/04104

(57) ABSTRACT

A multi-touch ultrasonic touchscreen is provided that includes a solid plate, an ultrasonic transducer disposed on an edge or surface of the solid plate that is capable of transmitting and receiving dispersive acoustic Lamb waves, and an appropriately programmed computer that is capable of operating the ultrasonic transducer to transmit and receive the dispersive acoustic Lamb waves, where the solid plate is capable of reflecting the transmitted dispersive acoustic Lamb waves internally and at edges and corners of the plate in a ubiquitous distribution within the solid plate, where the internal reflections include solid plate top and bottom surface reflections of the dispersive acoustic Lamb waves, where the edge and corner reflections are physical reflection to propagation of the dispersive acoustic Lamb waves, where the appropriately programmed computer is capable of operating on the received Lamb wave to determine an occurrence and location of a touch to the solid plate.

### FIELD OF THE INVENTION

The present invention relates generally to multi-touch screens. More particularly, the invention relates to active ultrasound propagation in the screen media of multi-touch screens.

### BACKGROUND OF THE INVENTION

Touchscreen sensors are widely used in many devices such as smart phones, tablets, laptops, etc. There are many different types of technologies that enable sensing the touch. None of these technologies are perfect and each has its own advantages and disadvantages. But the overall market size is very large.

The dominant technologies in the market are (1) Capacitive, (2) Resistive, (3) Acoustic, and (4) Optical touch systems. Among these, capacitive technologies, as the most dominant ones, have extreme hardware complexity. This makes them very inefficient in terms of power consumption. Acoustic technologies such as surface acoustic waves (SAW), acoustic pulse recognition (APR), and dispersive signal technology (DST) suffer from high sensitivity to noise. In addition, they require high touch pressure and cannot support multi-touch.

Capacitive touch technologies are the most common in the industry. Though, they suffer from hardware complexity, high manufacturing cost, low yield, and high power consumption. It is known that they also cause problems by affecting other functionalities of the device in which they are installed. For example, they tend to make the screen faint, for which case excess power is consumed to maintain the transparency. They may also have cross-talks with other electronics in the device. They work based upon conductivity of the touch object; so, any non-conductive object cannot be sensed.

Overall, the main difficulties of the current touch technologies are cost of manufacturing, complexity of the hardware/software, power consumption, and multi-touch capability. This has tremendously impeded their widespread applications for large screens.

What is needed is a touch system that is capable to detect human haptic interaction with the screen with the multi-touch capability. What is further needed is a device that demands much less hardware complexity and power consumption compared to the existing technologies.

### SUMMARY OF THE INVENTION

To address the needs in the art, a multi-touch ultrasonic touchscreen is provided that includes a solid plate, an ultrasonic transducer, where the ultrasonic transducer is disposed on an edge or surface of the solid plate, where the ultrasonic transducer is capable of transmitting and receiving dispersive acoustic Lamb waves, and an appropriately programmed computer, where the appropriately programmed computer is capable of operating the ultrasonic transducer to transmit and receive the dispersive acoustic Lamb waves, where the solid plate is capable of reflecting the transmitted dispersive acoustic Lamb waves internally and at edges and corners of the plate in a ubiquitous distribution within the solid plate, where the internal reflections include solid plate top surface reflections and solid plate bottom reflections of the dispersive acoustic Lamb waves, where the edge and corner reflections are physical reflection to propagation of the dispersive acoustic Lamb waves, where the appropriately programmed computer is capable of operating on the received acoustic Lamb wave to determine an occurrence and location of at least one touch to the solid plate.

According to one aspect of the invention, the ultrasonic transducer can include a capacitive micromachined ultrasonic transducer, electromagnetic acoustic transducers, thermal transducer, or piezoelectric transducer.

In another aspect of the invention, the internal reflection includes reflections by a top surface of the solid plate, a bottom surface of the solid plate and an edge of the solid plate.

In a further aspect of the invention, the solid plate is a plate selected from the group consisting of metal, plastic, glass, sapphire and quartz.

According to another aspect of the invention, the solid plate does not include gratings, etchings or reflective material.

In yet another aspect of the invention, the ultrasonic transducer is pulsed or modulated.

According to one aspect of the invention, the occurrence and location of the at least one touch is determined by the computer operation on the received acoustic lamb wave includes an algorithm such as tomographic reconstruction, beam forming, sparse array imaging, time reversal, machine learning or calibration-localization.

In a further aspect of the invention the transducer is disposed on an edge or surface according to connections that can include abutment, bonding, pressure coupling, laser welding, ultrasonic welding, electromagnetic coupling, or any methodology that imparts pressure to the edge or surface of the plate.

### BRIEF DESCRIPTION OF THE DRAWINGS

FIG. 1 shows a schematic of a glass plate with an array of transducers placed around the perimeter for imaging touch, according to one embodiment of the invention.

FIG. 2 shows a schematic of the displacement of the first order symmetric S₀ and anti-symmetric A₀ Lamb waves, according to one embodiment of the invention.

FIG. 3 shows a dispersion relation of Lamb waves in a plate of sapphire, according to one embodiment of the invention.

FIGS. 4a-4b show schematics of the relative displacements of the top and bottom surfaces of the solid plate with both symmetric S₀ and anti-symmetric A₀ Lamb waves, respectively and showing the polarization of the piezoelectric excitation transducer, according to one embodiment of the invention.

FIGS. 5a-5b show the displacement of a shear horizontal wave in a plate and its corresponding dispersion relation in a plate of aluminum, according to embodiments of the invention.

FIG. 6 shows piezoelectric crystal transducers in contact with a touchscreen, according to one embodiment of the invention.

FIGS. 7a-7b show images of propagation of the simulated dispersive acoustic Lamb wave-field, where 7a shows the absence of the touch, and 7b shows the presence of the touch in the middle of the screen, where the finger absorbs a portion of the dispersive acoustic Lamb wave energy, according to one embodiment of the invention.

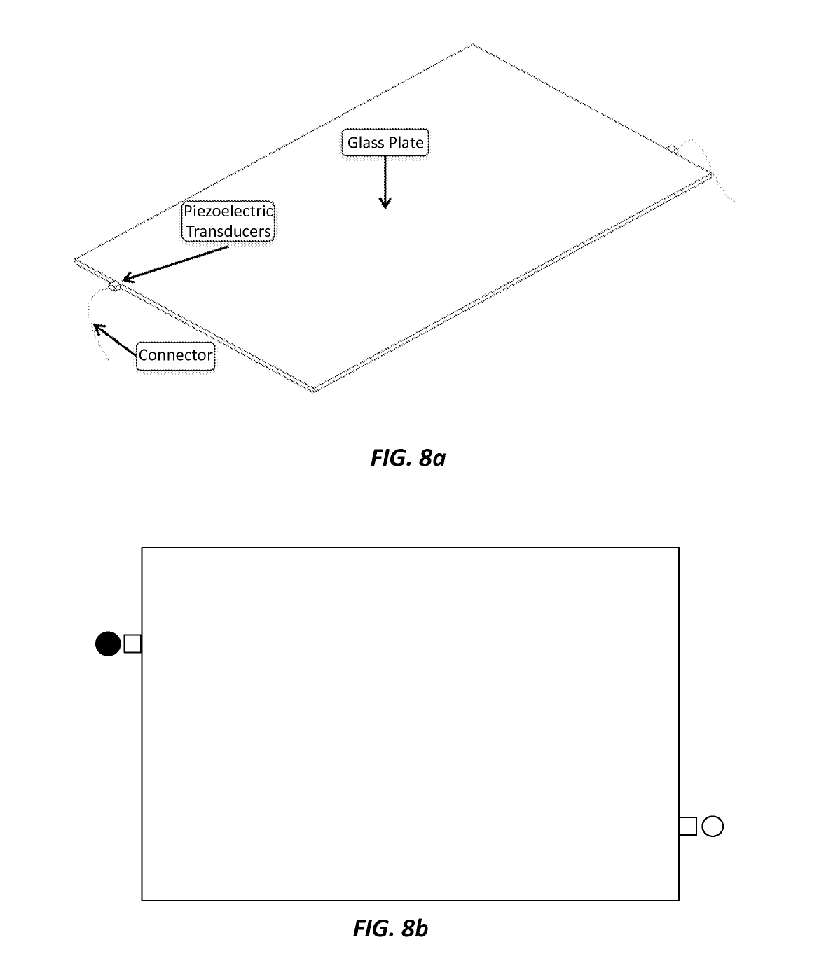

FIGS. 8a-8b show a prototype of the proposed ultrasound touchscreen with the key components labeled, where the open circle shows the transmit/receive channel, and the closed circle shows the receive-only channel, according to one embodiment of the invention.

FIG. 9 shows a-scan corresponding to the ultrasound touchscreen prototype, where the waves are transmitted by the transducer indicated in grey and received by the one shown in black, and the black signal represents the reference signal (i.e., no touch) and the grey signal is the one after touching the plate, where the touch induces changes on the no-touch signal, according to one embodiment of the invention.

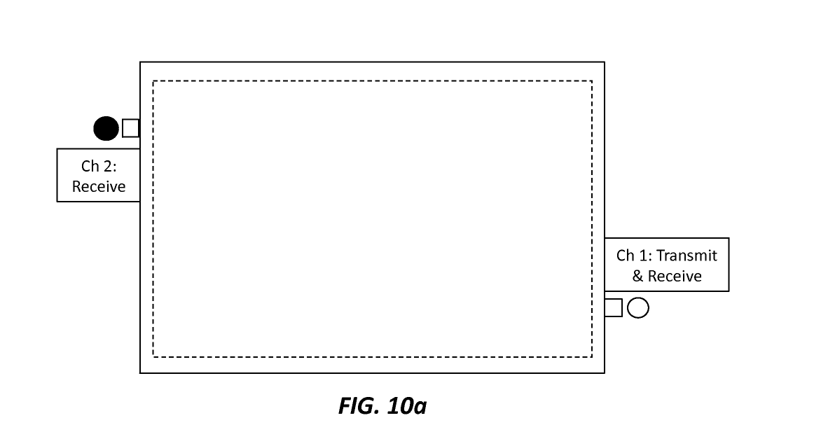

FIGS. 10a-10c show 10a calibration setting for constructing the training set, 10b the result of the localization algorithm for a simultaneous five-touch test indicating the actual (random) touch positions on the plate of 10a, and 10c shows the output of the algorithm having the inverted touch positions, matching the actual ones.

### DETAILED DESCRIPTION

The invention provides a novel ultrasound touch sensor with reduced hardware complexity, higher efficiency, and multi-touch capability compared to the existing technologies.

According to one embodiment of the invention, an ultrasonic touch screen capable of multi-touch imaging is provided. In one aspect, a single piezoelectric transducer or arrays of piezoelectric transducers are attached to the sides of the touch screen plate. The transducer elements of the array are used as both transmitters and receivers whose signals are used to reconstruct images of the absorption and/or delay of the ultrasonic waves due the touch of the screen. According to one embodiment, the piezoelectric transducers are edge bonded or connected with a dimension equal to that of the plate so that there are no protrusions above the plate. The piezoelectric elements are polarized in different direction in order to selectively excite Lamb waves (both symmetric and/or anti-symmetric) or Love waves (shear horizontal polarized). The choice of the excitation mode is according to the sensitivity of the various modes of propagation in the plate touch, and the ability to excite multiple modes at the same time to result in a self-calibrating differential measurement.

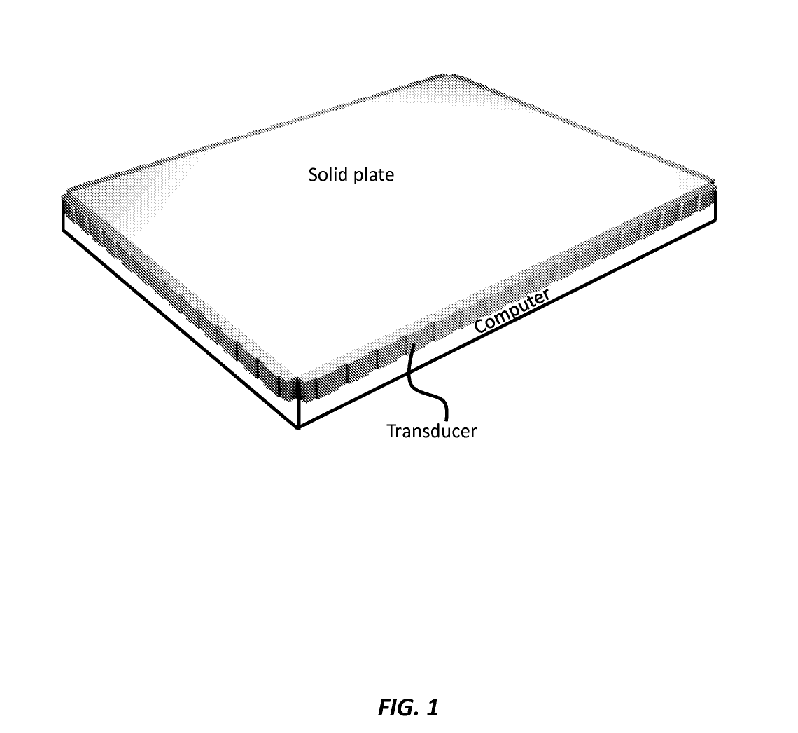

The current invention is advantageous in several respects. The solid plate does not require any layers, metal traces, gratings, etchings or reflectors. According to other embodiments of the invention, the transducer is disposed on an edge or surface according to connections that can include abutment, bonding, pressure coupling, laser welding, ultrasonic welding, electromagnetic coupling, or any methodology that imparts pressure to the edge or surface of the plate. In a further embodiment, the transducer elements contacting the piezoelectric plate are defined with non-critical lithography, as the dimensions are of the order of a wavelength of the ultrasound wave or of the order of mille-meter. Because the shape of the plate is fixed, the data can be collected from very specific instants in time, which make data collection and inversion in compliance with a requirement of 100 Hz necessary for multi-touch identification and tracking. Also, because arrays of elements are used to image the location of a finger, the resolution is determined by diffraction limited ultrasonic wave propagation, and thus hundreds or even thousands of resolution points will be available on a 13″ by 10″ solid plate, for example. A schematic of one embodiment of the multi-touch screen having transducers and an appropriately programmed computer is shown in FIG. 1.

According to one embodiment of the invention, the transducers are capable of exciting various modes of propagation in the plate. For example, in a phased array embodiment, each element is chosen to be half a wavelength wide at the frequency of operation and for the mode of propagation chosen. A pulse excites each element, and received signals are collected from all the other elements. This excitation and reception is then sequentially applied to all the other elements of the array. Once all the data is collected, an image is reconstructed to show a location where energy was removed from the propagation wave, such as by touch. This is analogous to tomographic reconstruction of the absorption of the waves as they propagate from transmitter to receiver. Different modes of propagation have different sensitivities to touch.

According to different embodiments of the invention, various types of modes of ultrasonic waves are capable of propagation in a plate. Below, the various modes of propagation are considered that are possible with some of their characteristics.

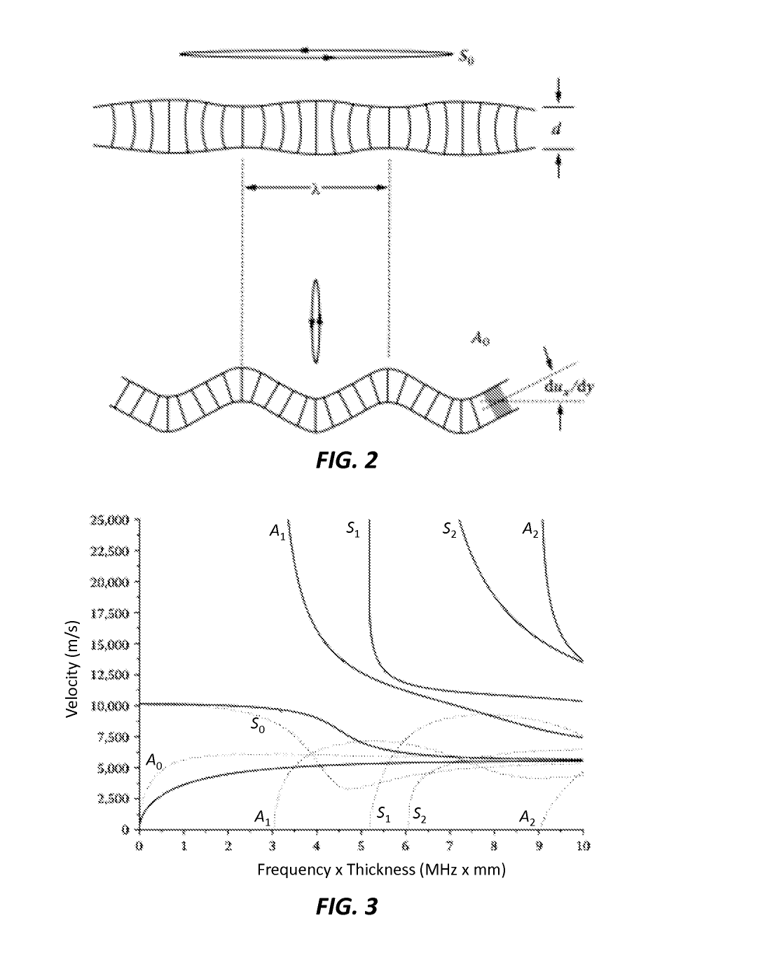

According to the current invention, Lamb waves are generated by transducers contacting a solid plate. Lamb wave is the name given to waves that involve both the top and bottom surfaces of a plate, and that contain a combination of longitudinal and shear mode propagation. For example, the direction of the shear has a component in the direction perpendicular to the plate. There are two solutions to the wave equation in the plate, one solution for symmetric Lamb S₀ waves where the symmetry of the displacement is with respect to the center plane of the plate, and anti-symmetric Lamb A₀ waves. In analogy with microwave propagation in waveguides, there are an infinite number of modes of each type. FIG. 2 shows a schematic of the displacement of the lowest order symmetric (S₀) and anti-symmetric (A₀) Lamb waves.

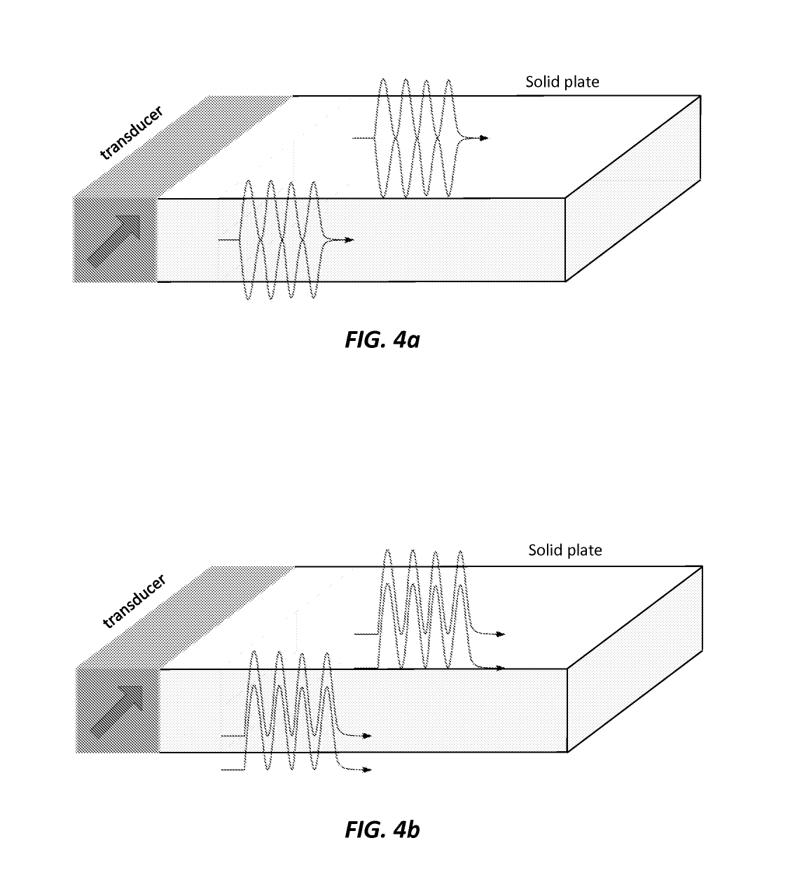

Lamb waves are dispersive (velocity is a function of frequency for a fixed thickness of the plate) and come in many modes. In one embodiment of the invention only the two lowest order modes are used in order to make the inversion of the arrival times and amplitudes more amenable for a robust system implementation. FIG. 3 shows the dispersion relations for both phase and group velocities for a plate of sapphire, according to one embodiment of the invention. Note that the horizontal axis is in units of frequency multiplied by the thickness of the plate. And that for low values of this product, only the S₀ and A₀ modes exist, and thus are implemented according to the invention.

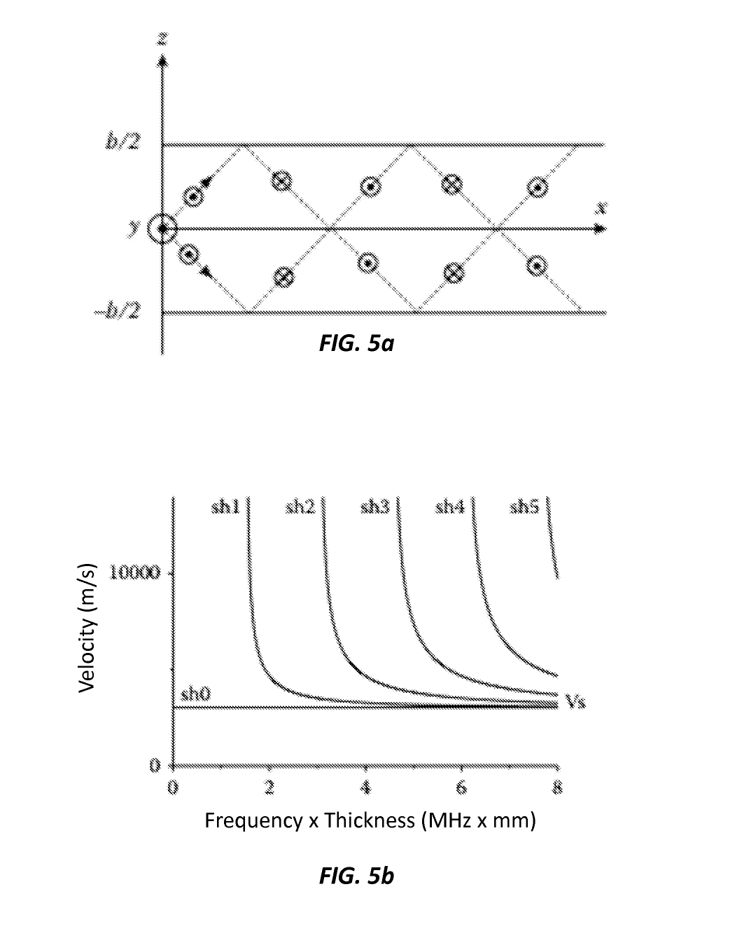

In order to excite only the two lowest order modes, an edge-contacting transducer is used with the polarization of the piezoelectric as shown in FIGS. 4a-4b. Note that by choosing the thickness of the piezoelectric we set a frequency of operation. Thus, given the thickness of the glass plate, the frequency thickness product can be set to only allow the lowest order modes to be excited. Note that the S₀ is much faster than the A₀, hence these two modes can be separated in the time domain, and thus obtain relative measurements of the finger or multiple finger contact loss, and thus image the contacts more accurately.

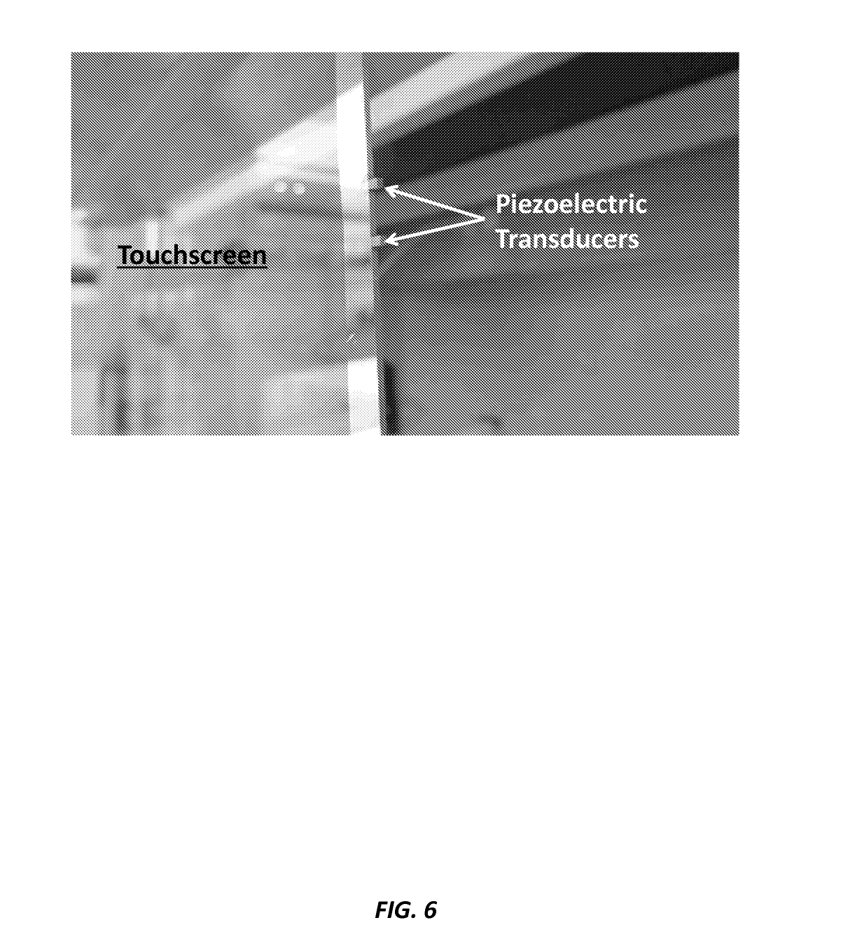

Modes with shear horizontal (SH) (polarization parallel to the plane of the plate) polarization can exist in plates with low and high order modes depending on the frequency. In this type of wave, only the shear horizontal displacement is needed to maintain the mode that also means that reflection at the top and bottom surfaces of the plate do not result in mode conversion into longitudinal waves. FIGS. 5a-5b show the polarization of shear horizontal mode in a plate, and corresponding dispersion relation of a plate made of aluminum. When a finger touches the plate, the SH wave is modified by the presence of the finger and the wave character changes in that energy are coupled to the finger, and the mode is then known as a Love wave. This change is necessary in order to have sensitivity to the presence of the finger, and to allow imaging of the location of the finger. The type of dispersion relation of the Love wave depends on the plate and its material and thickness, the frequency and the type of loading, in this case human tissue.

The excitation of SH or Love waves is practical, where an edge-bonded transducer is used, however in this case the piezoelectric is polarized in the direction parallel to the plane of the plate. The thickness of the piezoelectric establishes the frequency of operation, and the product of the frequency times the thickness sets the number of modes that are excited in the plate.

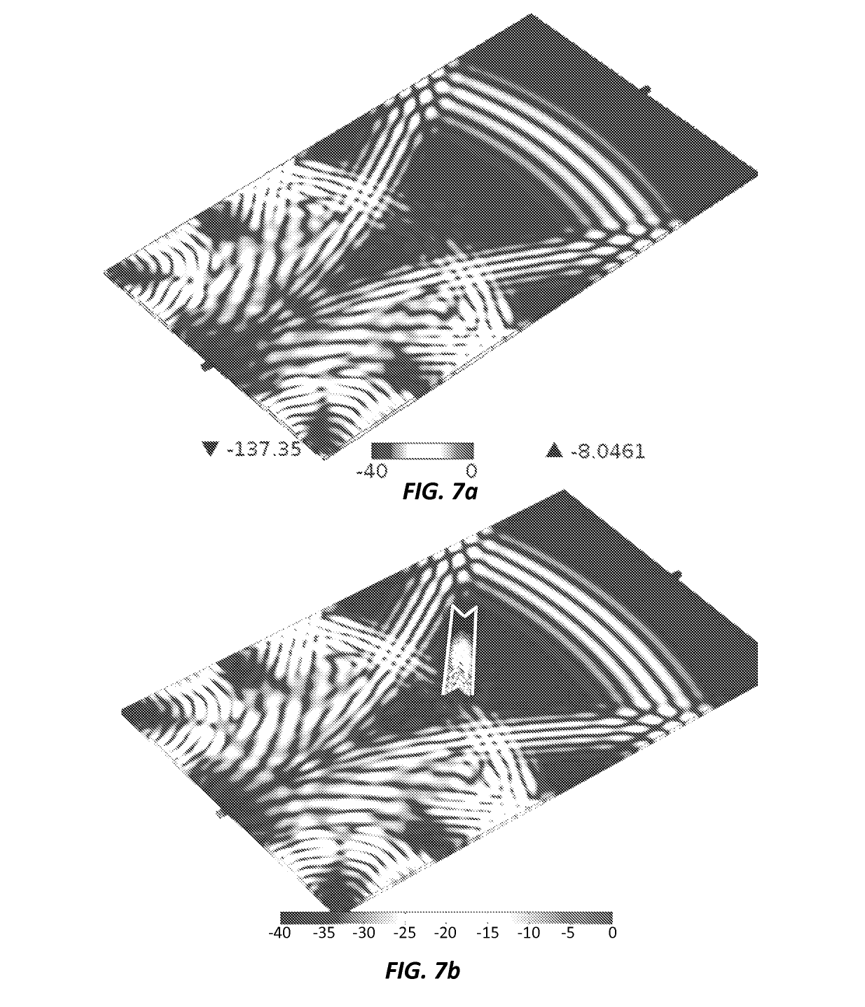

In another embodiment of the current invention small piezoelectric transducers integrated with a plate (see FIG. 6). According to one embodiment of the current invention, the transducers are selectively pulsed repeatedly to create a propagating dispersive Lamb wave-field inside the plate. The field is then measured at a selection of the transducers, which can include the transmitters according to one embodiment. The plate operates in a quasi-free-stress condition over its top surface. Upon having one or more touches, a localized pressure is created at the touch region and hence a portion of the wave-field is absorbed through the finger(s). This absorption alters the reference signals (i.e. the signals measured when there is no touch) in many ways such as reducing energy, introducing phase-shifts, etc. Different signatures are induced on the reference signal, corresponding to different positions of touches, number of touches, and contact areas, which makes a sample touch distinct from other possible touch configurations.

This is results from the physics governing the wave-field inside the plate, that is, since the geometry is strongly bounded, the wave field is strongly dispersive and also undergoes a high amount of reflections from the boundaries of the plate. The whole screen is interrogated several times by the presence of a ubiquitous distribution of dispersive Lamb waves. Every point of the plate is met multiple times by the rays from different directions so that a touch is guaranteed to affect the wave-field in a unique way. Because of the boundedness of the geometry, none of the information can escape from the domain, where all information is preserved and accessible through measurements at the edges. This aspect is shown in the physics-based numerical simulation in FIGS. 2a-2b.

According to other embodiments, the invention includes inversion where the positions of the touches are inferred from the signatures. In one embodiment of the inversion aspect of the invention, tomographic reconstruction of the touches are used, where transducers are closely packed on the perimeter of the screen and form scan lines by grouping transducers into a pair of transmitters and receivers. For each scan line, absorption of the transmitted signal (induced by the finger) is projected onto the edges encompassing the receivers. This is done by multiple grouping of the transmitter/receivers to cover all the perimeter of the screen surface.

In another embodiment of the inversion aspect, beam forming is used, where transducer elements are placed close together and steered to form ultrasound beams in the plate and thereby measure the echoes generated by the touch.

In a preferred embodiment of the inversion aspect, sparse array imaging is used, where transducers are placed in a sparse configuration with respect to each other. The touch position is then inferred based upon the arrival time of the perturbations that the touch creates on the waves. According to some aspects of the current embodiment, the touch position is determined using different techniques that include hyperbolic imaging, parabolic imaging, and tomographic imaging.

In one aspect of inversion step, time-reversal is used, where the received signal is reversed and emitted back into screen domain numerically. The time-reversed waves get focused at the source of the touch contact. This is because of time reversibility of the wave-physics governing the system. Any heightened demand of computational power is mitigated when a set of calibration points is used, where the issue is reduced to a calibration-based method. Here, the screen is touched at selective points with a controlled uniform contact area. The signals of each test along with the signals of the no-touch condition are stored in memory. Offline computations are performed on the stored data. Upon having a touch, the measured signals at each receiver is compared with all or portions of the calibration signals that correspond to the same transducer.

The calibration creates a data space, or a training set, which makes a number of algorithms in the context of machine learning and signal processing applicable to the inversion stage. These include correlation-based methods, projection based methods, nonlinear regression, linear and nonlinear classifiers, supervised learning algorithms, and generative learning algorithms.

The training set constructed based upon a purely or semi-theoretical basis, in which case no calibration stage or a very limited number of calibration measurements is required.

An exemplary algorithm for the multi-touch ultrasonic touchscreen is provided, where for the calibration step having a given transmit-receive scheme, the screen is touched using an ultrasound-absorptive phantom (i.e., a material with an acoustic impedance close to that of a touch object such as human finger) on a selected set of points arranged over a rectangular grid. The corresponding signals are acquired and stored in a hard-drive on an appropriately programmed computer. The size of the phantom as well as the system parameters such as sampling rate, number of acquired samples, and spacing between the calibration points depend on the size of the screen, frequency content of the input, accuracy and resolution of interest. After storing the raw signal, several processing techniques are performed including, but not limited to, filtering and time gain control. The calibration signals are then stored in a matrix [symbol] whose columns are the processed calibration signals, i.e. the matrix has dimensions Nₛ×N_{c}, where Nₛ is the number of acquired samples and N_{c} is the number of calibration points. The calibration signals are then orthogonalized using the QR method, that is [symbol] is decomposed as [symbol] = [symbol] [symbol] , where [symbol] is a unitary matrix and [symbol] is an upper triangular matrix. The calibration signals construct a so-called training set.

Upon having a touch, the measured signal at each receiver undergoes a similar signal processing to that of the training set. The measured signals are then corrected for drift and noise of the system. Further, they may be transformed by a set of operations governed by the matrices [symbol] and [symbol] . The outcome of this process, ψ, is then fed into an optimization process:

$${min}_{θ ∈ {ℝ}^{{N}_{c}}} {\sum }_{k = 1}^{{N}_{t}} {\sum }_{i = 1}^{{N}_{r}} {γ}^{( k , l )} {‖ {ℳ}^{( k , l )} θ - {ψ}^{( k , l )} ‖}_{{l}^{2}}^{2} + λ {‖ θ ‖}_{{l}^{2}}^{2} + μ {‖ θ ‖}_{{l}^{1}} , \\ subject to {θ}_{i} \geq 0 , for i = 1 , … , {N}_{c} , ;$$

where λ, η, and γ(k,l)'s are the penalty parameters tuned to achieve the optimum performance. Nₜ and Nᵣ are the number of transmitters and receivers, respectively. The index pair (k; l) indicates the variable corresponding to the k^{th} transmitter and l^{th} receiver. The solution of this stage is an N_{c} dimensional vector (i.e., an array with N_{c} tuples, θ=(θ, . . . , θ_{N}_{_{c}})). Each entry of the solution vector represents the likelihood of having a touch at the corresponding point in the training set.

The solution obtained in the localization stage is fed into a priori calculated theory-based interpolation scheme as

$$𝒥 ( x , y ) = {\sum }_{i = 1}^{{N}_{c }} {θ}_{i} {p}_{i} ( x , y ) ,$$

where x; y are the coordinates over the screen and [symbol] (x, y) gives the likelihood of having a touch at the position (x; y). pᵢ(x; y)'s are the interpolation basis functions. The values of [symbol] (x, y) greater than or equal to a set threshold indicate the touch positions.

Some variations to the above described method includes using all the above mentioned processing steps implemented using the envelopes of the signals, or implemented using the Fourier transformed signals. Further, the training set can be constructed using a theory-based framework.

In general, a partitioning scheme can be used, in which case the screen is divided in to smaller partitions and the training set is decomposed accordingly. The procedure of the localization stage is iterated over all the partitions and the union of the solutions given by each partition is accepted as the localized touches. In a further variation, the entire algorithm can be re-formulated in an inner-product form. This can be used to replace the inner product operator by a reasonably chosen function of the inner product (also known as “kernel”).

In another variation, the constraint of the optimization problem can be removed, in which case the solution vector may have negative entries. The absolute value of the entries is accepted as the solution. The optimization constraint can also be relaxed, or enhanced depending on the performance of interest.

The optimization objective can be altered to any reasonably chosen nonlinear quasi-convex function, or the localization stage can be replaced by the clustering algorithms. One embodiment of this type is the k-means clustering algorithm, in which case the touch signal is combined with the calibration signals and the algorithm is asked to cluster the signals using a measure of similarity of features between the signals such as Euclidean distance, cross-correlation, etc.

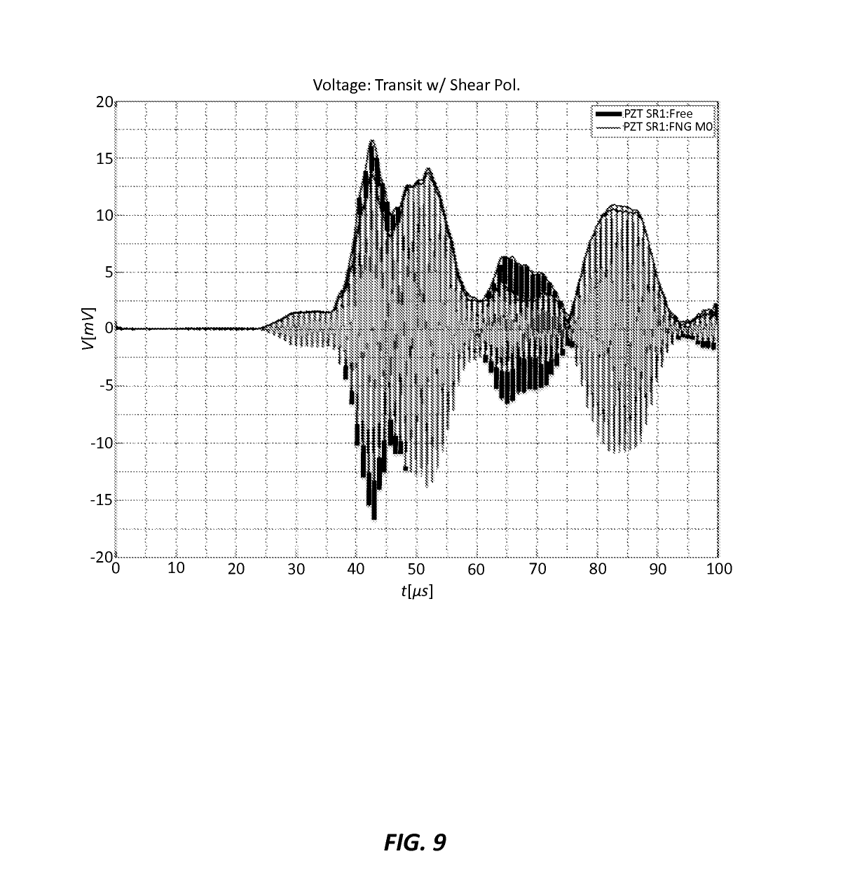

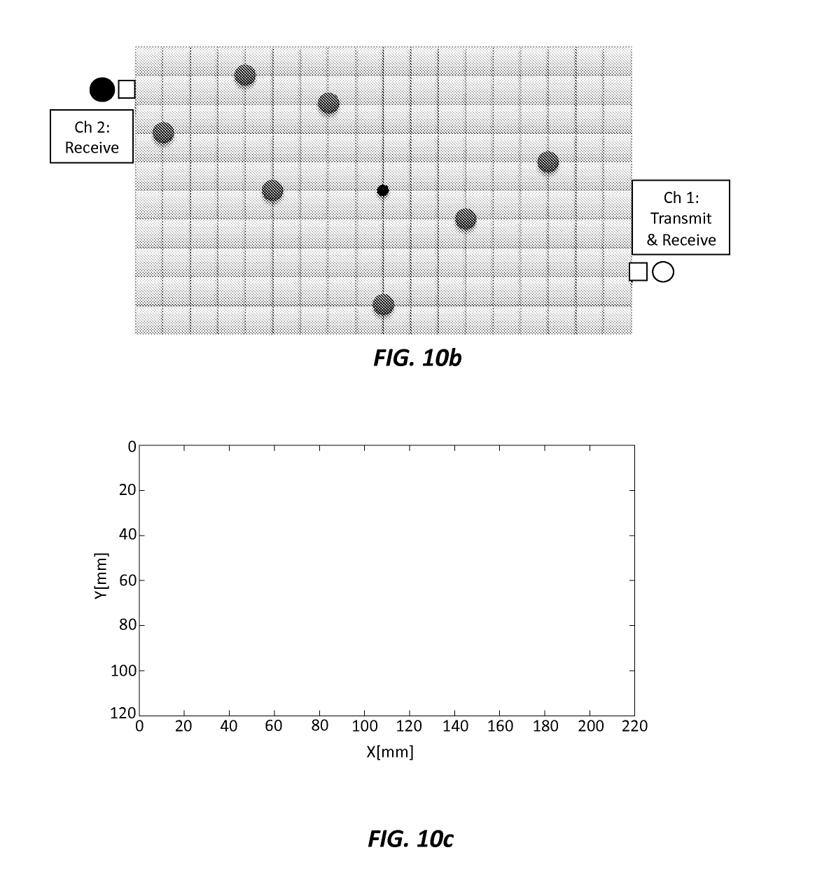

An exemplary touchscreen was fabricated that includes the inversion method and is provided herein, according to one embodiment of the invention. This example touchscreen includes a glass plate and two transducers attached to it (see FIGS. 8a-8b and FIG. 10a).

In FIG. 8b and FIG. 10a, the transducer on the right (indicated by the open white circle) is used to transmit and receive the mechanical waves and the one on the left (indicated by the solid black circle) is used only to receive the waves.

Here a projection-based method was used to localize the touches. As explained in the previous section, for the projection method a training data set is required. In the projection algorithm, the training set is used to form a data space. Then, for a touch, the algorithm finds a projection of the touch data over the training data space. The projection coefficients are then used to infer the locations of the touches.

For the purpose of illustration, a training set was acquired by calibrating the plate over the dashed box region (FIG. 10a). A test with seven simultaneous touches was then conducted to prove the functionality of the proposed concept. The RF signal from the single receive transducer is measured, digitized, and transferred to a computer for processing. The result of the inversion algorithm is presented in FIGS. 10b-10c, showing the location of all seven touches

The ultrasound-based touch technology hardware according to the current invention is far less complex that conventional touchscreens, resulting in high yield, less manufacturing cost, and operating power consumption. It is sensitive to any touch object that can create acoustic pressure and absorb sound such as finger, gloved finger, pen, etc.

Compared to the existing acoustic touch technologies, some of unique features are (1) multi-touch capability, (2) less sensitivity to ambient noise, (3) low touch pressure, (4) low cost, and (5) possibly even smaller number of transducers.

The present invention has now been described in accordance with several exemplary embodiments, which are intended to be illustrative in all aspects, rather than restrictive.

Thus, the present invention is capable of many variations in detailed implementation, which may be derived from the description contained herein by a person of ordinary skill in the art. All such variations are considered to be within the scope and spirit of the present invention as defined by the following claims and their legal equivalents.

What is claimed:

1. A multi-touch ultrasonic touchscreen comprising:
a. a solid plate;
b. an ultrasonic transducer, wherein said ultrasonic transducer is disposed on an edge or surface of said solid plate, wherein said ultrasonic transducer is capable of transmitting and receiving dispersive acoustic Lamb waves; and
c. an appropriately programmed computer, wherein said appropriately programmed computer is capable of operating said ultrasonic transducer to transmit and receive said dispersive acoustic Lamb waves, wherein said solid plate is capable of reflecting said transmitted dispersive acoustic Lamb waves internally and at edges and corners of the plate in a ubiquitous distribution within said solid plate, wherein said internal reflections comprise solid plate top surface reflections and solid plate bottom reflections of said dispersive acoustic Lamb waves, wherein said edge and corner reflections comprise physical reflection to propagation of said dispersive acoustic Lamb waves, wherein said appropriately programmed computer is capable of operating on said received acoustic Lamb wave to determine an occurrence and location of at least one touch to said solid plate.

2. The multi-touch ultrasonic touchscreen of claim 1, wherein said ultrasonic transducer is selected from the group consisting of a capacitive micromachined ultrasonic transducer, electromagnetic acoustic transducers, thermal transducer, and piezoelectric transducer.

3. The multi-touch ultrasonic touchscreen of claim 1, wherein said internal reflection comprises reflections by a top surface of said solid plate, a bottom surface of said solid plate and an edge of said solid plate.

4. The multi-touch ultrasonic touchscreen of claim 1, wherein said solid plate is a plate selected from the group consisting of metal, plastic, glass, sapphire and quartz.

5. The multi-touch ultrasonic touchscreen of claim 1, wherein said solid plate does not include gratings, etchings or reflective material.

6. The multi-touch ultrasonic touchscreen of claim 1, wherein said ultrasonic transducer is pulsed or modulated.

7. The multi-touch ultrasonic touchscreen of claim 1, wherein said occurrence and location of said at least one touch is determined by said computer operation on said received acoustic Lamb wave comprises an algorithm selected from the group consisting of tomographic reconstruction, beam forming, sparse array imaging, time reversal, machine learning and calibration-localization.

8. The multi-touch ultrasonic touchscreen of claim 1, wherein said transducer is disposed on an edge or surface according to connections selected from the group consisting of abutment, bonding, pressure coupling, laser welding, ultrasonic welding, electromagnetic coupling, or any methodology that imparts pressure to the edge or surface of the plate.
